(19) United States
(12) Patent Application Publication
(10) Pub. No.: US 2026/0288245 A1
(43) Pub. Date: Sep. 24, 2026

(54) PRESSURE SENSATION PRESENTATION SYSTEM AND CONTROL APPARATUS

(71) Applicant: Sony Group Corporation, Tokyo (JP)

(72) Inventors: Kentaro YOSHIDA, Kanagawa (JP); Ryo YOKOYAMA, Tokyo (JP); Hironobu ABE, Kanagawa (JP); Yusuke NAKAGAWA, Kanagawa (JP)

(21) Appl. No.: 18/874,231

(22) PCT Filed: May 23, 2023
(86) PCT No.: PCT/JP2023/019079

§ 371 Date: Dec. 12, 2024

(30) Foreign Application Priority Data
Jun. 28, 2022 (JP) 2022-104018

(51) Int. Cl. G06F 3/01

(52) U.S. Cl. CPC G06F 3/016; G06F 3/014

(57) ABSTRACT

To provide a pressure sensation presentation system and a control apparatus that can present a pressure sensation to a user more clearly.

A pressure sensation presentation system according to an embodiment of the present technology includes an output apparatus, a determination apparatus, and a control apparatus. The output apparatus applies a physical stimulus for presenting a pressure sensation to a user. The determination apparatus determines a state of a preset action of the user. The control apparatus includes a generation unit that generates a first driving signal to apply a first physical stimulus to the user when the state of the action is a first state, a second driving signal to apply a second physical stimulus different from the first physical stimulus to the user when the state of the action is a second state, and a third driving signal to apply a third physical stimulus to the user in a transition from the first state to the second state, the third physical stimulus including at least one of an upwardly convex change or a downwardly convex change in an amount of physical stimulus.

### TECHNICAL FIELD

The present technology relates to a pressure sensation presentation system and a control apparatus that are for presenting a pressure sensation to a user.

### BACKGROUND ART

One of the tactile stimuli is a pressure stimulus. For example, technologies for presenting a pressure sensation to a user are known. For example, Patent Literature 1 describes that the changes in contact area between a user and a device that presents tactile stimuli and the changes in contact area in transition from a contact state to a non-contact state are controlled in order to present a hard or soft sensation or a sticky sensation to the user.

### CITATION LIST

### Patent Literature

Patent Literature 1: Japanese Unexamined Patent Application Publication No. 2017-175868

### DISCLOSURE OF INVENTION

### Technical Problem

However, in Patent Literature 1, there has been a problem that it is difficult to clearly express a pressure sensation to a user because it only follows changes in contact area in response to the displacement of the user.

In view of the circumstances as described above, it is an object of the present technology to provide a pressure sensation presentation system and a control apparatus that can present a pressure sensation to a user more clearly.

### Solution to Problem

A pressure sensation presentation system according to an embodiment of the present technology includes an output apparatus, a determination apparatus, and a control apparatus.

The output apparatus applies a physical stimulus for presenting a pressure sensation to a user.

The determination apparatus determines a state of a preset action of the user.

The control apparatus includes a generation unit that generates a first driving signal to apply a first physical stimulus to the user when the state of the action is a first state, a second driving signal to apply a second physical stimulus to the user when the state of the action is a second state, and a third driving signal to apply a third physical stimulus to the user in a transition from the first state to the second state, the third physical stimulus including at least one of an upwardly convex change or a downwardly convex change in an amount of physical stimulus.

The third physical stimulus may be different from the second physical stimulus.

The third physical stimulus may include, during the transition from the first state to the second state, a first step in which the amount of physical stimulus increases, and a second step in which the amount of physical stimulus decreases.

The output apparatus may include a contact unit that comes into contact with the user, and the output apparatus may apply a contact stimulus as the physical stimulus between the user and the contact unit.

The output apparatus may include a compressive force presentation unit that applies a compressive force as the physical stimulus to the user.

The third physical stimulus may include a step in which a contact area between the user and the contact unit that changes an area to which the compressive force is applied by the compressive force presentation unit increases and the compressive force decreases, and a step in which the contact area decreases and the compressive force increases.

The control unit may change a compressive area in which the user and the compressive force presentation unit are in contact with each other.

The third physical stimulus may include a step in which the area to which the compressive force is applied to the user by the compressive force presentation unit increases and the compressive force decreases, and a step in which the area to which the compressive force is applied to the user by the compressive force presentation unit decreases and the compressive force increases.

The third physical stimulus may include a step in which the compressive area increases and the compressive force decreases, and a step in which the compressive area decreases and the compressive force increases.

The output apparatus may include a vibration presentation unit that applies a vibration stimulus as the physical stimulus to the user.

The vibration stimulus may be a damped vibration.

The vibration stimulus may include a frequency component of 200 Hz or more and 1000 Hz or less.

The output apparatus may further include a warm sensation presentation unit that applies a warm sensation stimulus as the physical stimulus to the user.

The warm sensation presentation unit may come into contact with the user, and the control unit may change a contact area in which the warm sensation presentation unit is in contact with the user when the warm sensation stimulus is applied to the user by the warm sensation presentation unit.

The third physical stimulus may include a plurality of the first steps and a plurality of the second steps.

A control apparatus according to an embodiment of the present technology includes a generation unit.

The generation unit generates, on the basis of a determination result of a determination apparatus that determines a state of a preset action of the user, for an output apparatus that applies a physical stimulus for presenting a pressure sensation to the user,
a first driving signal to apply a first physical stimulus to the user when the state of the action of the user is a first state,
a second driving signal to apply a second physical stimulus to the user when the state of the action is a second state, the second driving signal being different from the first driving signal, and
a third driving signal to apply a third physical stimulus to the user in a transition from the first state to the second state, the third physical stimulus including at least one of an upwardly convex change or a downwardly convex change in an amount of physical stimulus.

### BRIEF DESCRIPTION OF DRAWINGS

FIG. 1 is a block diagram showing a configuration of a pressure sensation presentation system in a first embodiment of the present technology.

FIG. 2 is a view showing a use example of an output apparatus, in which (A) is a view of the back side of the user's hand, and (B) is a view of the palm side of the user's hand.

FIG. 3 is a view showing a cross section of the output apparatus, in which (A) is a cross-sectional view seen from a side surface of the user's finger, and (B) is a cross-sectional view seen from the front of the user's finger.

FIG. 4 is a diagram showing changes in a state where a physical stimulus for presenting a pressure sensation is applied to the user.

FIG. 5 is a diagram showing a use example of the pressure sensation presentation system in the first embodiment.

FIG. 6 is a flowchart of the pressure sensation presentation system in the first embodiment.

FIG. 7 is a diagram relating to an application example of the pressure sensation presentation system in the first embodiment.

FIG. 8 is a diagram showing changes in the state where a change in physical stimulus is applied before an event occurs.

FIG. 9 is a diagram showing patterns of change in contact area that are presented to the user, in which (A) is a diagram showing a damping pattern, and (B) is a diagram showing an amplification pattern.

FIG. 10 is a diagram showing changes in a state where a physical stimulus for presenting a pressure sensation and a compressive force is applied to the user.

FIG. 11 is a diagram showing a pattern that presents a pressure sensation to the user, in which (A) is a diagram showing a vibration pattern in the case where the contact area decreases from a first state to a second state, (B) is a diagram showing a vibration pattern in the case where the contact area increases from the first state to the second state, and (C) is a diagram showing a temperature change.

FIG. 12 is a diagram relating to an application example 2-1 in which a pressure sensation is presented to a user by using a contact area, a compressive force, and vibration.

FIG. 13 is a diagram relating to an application example 2 -2 in which a pressure sensation is presented to a user by using a contact area, a compressive force, and vibration.

FIG. 14 is a diagram relating to an application example 2-3 in which a pressure sensation is presented to a user by using a contact area, a compressive force, and vibration.

FIG. 15 is a diagram relating to an application example 2-4 in which a pressure sensation is presented to a user by using a contact area, a compressive force, and vibration.

FIG. 16 is a diagram relating to an application example 2-5 in which a pressure sensation is presented to a user by using a contact area, a compressive force, and vibration.

FIG. 17 is a diagram relating to an application example 2-6 in which a pressure sensation is presented to a user by using a contact area, a compressive force, and vibration.

FIG. 18 is a diagram relating to an application example 2-7 in which a pressure sensation is presented to a user by using a contact area, a compressive force, and vibration.

FIG. 19 is a diagram relating to an application example 2-8 in which a pressure sensation is presented to a user by using a contact area, a compressive force, and vibration.

FIG. 20 is a diagram relating to an application example 2-9 in which a pressure sensation is presented to a user by using a contact area, a compressive force, and vibration.

### MODE(s) FOR CARRYING OUT THE INVENTION

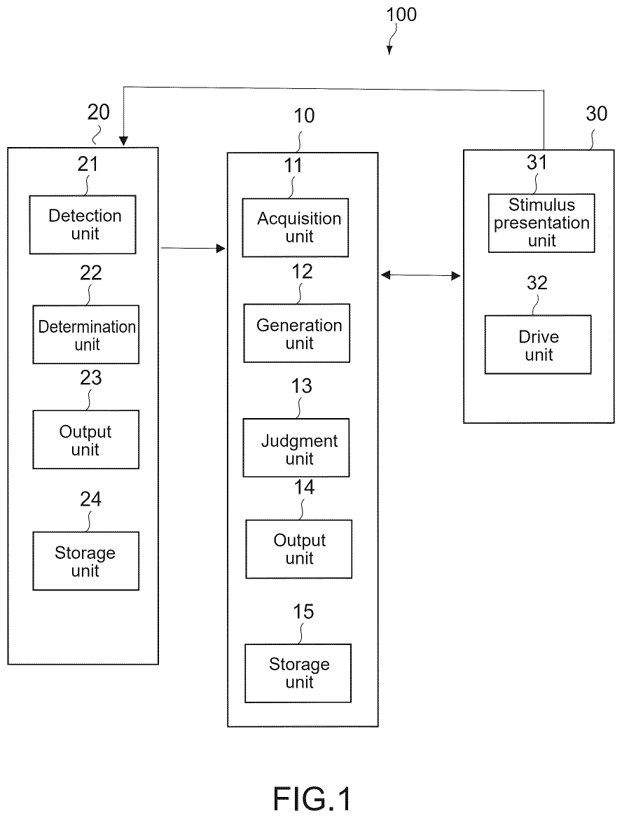

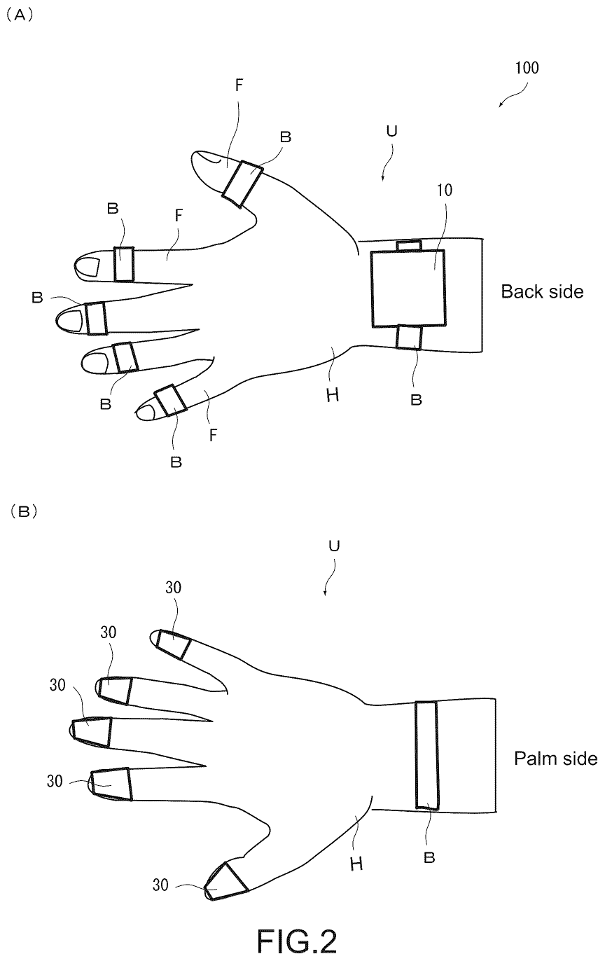

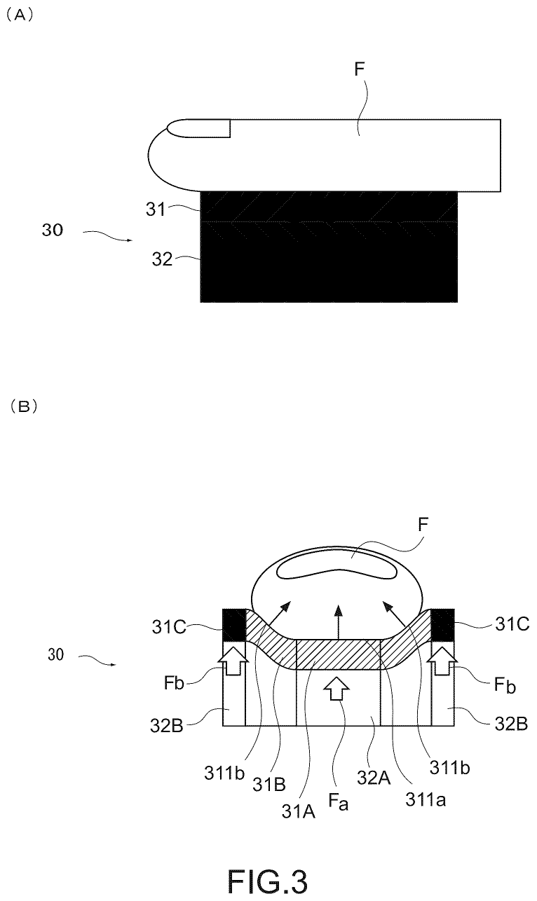

Hereinafter, embodiments according to the present technology will be described with reference to the drawings. FIG. 1 is a block diagram showing a configuration of a pressure sensation presentation system 100 of this embodiment. FIG. 2 is a view showing a use example of an output apparatus 30, in which (A) is a view of the back side of a hand H of a user U, and (B) is a view of the palm side of the hand H of the user U. FIG. 3 is a view showing a cross section of the output apparatus 30, in which (A) is a cross-sectional view seen from a side surface of a finger F of the user U, and (B) is a cross-sectional view seen from the front of the finger F of the user U.

### First Embodiment

As shown in FIG. 1, the pressure sensation presentation system 100 includes a control apparatus 10, a determination apparatus 20, and an output apparatus 30.

### Output Apparatus

As shown in FIGS. 1 to 3, the output apparatus 30 is a device that includes a stimulus presentation unit 31 and a drive unit 32 and can apply a physical stimulus for presenting a pressure sensation to a user U. Here, the pressure sensation refers to one of cutaneous sensations and is a sensation that occurs when the skin or other part of the body is compressed or pulled. Additionally, the physical stimulus includes pressure, vibration, electrical stimulus, wind, ultrasound, etc., and stimuli in the size and distribution of the area over which they are presented.

In this embodiment, the output apparatus 30 is mounted on fingers F of the user U as shown in (A) and (B) of FIG. 2. The output apparatus 30 is fixed to the fingers F of the user U by a band B.

As shown in (A) and (B) of FIG. 3, the stimulus presentation unit 31 includes a first stimulus presentation unit 31A having a first contact surface 311a that comes into contact with the center portion of the ball of the finger F of the user U, a second stimulus presentation unit 31B connected to the first stimulus presentation unit 31A and having a second contact surface 311b that comes into contact with the circumference of the ball of the finger F, and an end portion 31C connected to the side of the second stimulus presentation unit 31B that is opposite to the side connected to the first stimulus presentation unit 31A. The material of the stimulus presentation unit 31 is not particularly limited. The shape of the stimulus presentation unit 31 that is made of an elastic material such as silicon rubber or urethane rubber is not particularly limited, but can be, for example, rectangular or circular and only needs to be a shape that can come into contact with the ball of the finger F.

The drive unit 32 includes a first drive unit 32A that drives the first stimulus presentation unit 31A, and a second drive unit 32B that drives the second stimulus presentation unit 31B. In this embodiment, the first drive unit 32A controls the first stimulus presentation unit 31A to be driven in a direction in which the first stimulus presentation unit 31A serving as a contact unit is pressed against the finger F or in a direction in which the first stimulus presentation unit 31A is moved away from the finger F. This makes it possible to present a sensation that the first stimulus presentation unit 31A comes into contact with a portion of the ball of the finger F (contact stimulus as physical stimulus) by the first drive unit 32A.

Additionally, the second drive unit 32B controls the end portion 31C to be driven in a direction in which the end portion 31C is moved closer to the finger F or in a direction in which the end portion 33 is moved away from the finger F. The second drive unit 32B moves the end portion 31C to the finger F side, which makes it possible to cause the second stimulus presentation unit 31B to come into contact with the side surface of the finger F along therewith and to present a sensation that the second stimulus presentation unit 31B comes into contact with a portion of the side surface of the finger F (contact stimulus as physical stimulus) by the second drive unit 32B.

The method of controlling the stimulus presentation unit 31 by the drive unit 32 is not particularly limited, but the control can be performed by, for example, a spring or air pressure.
Additionally, in this embodiment, the output apparatus 30 is mounted on the fingers F of the user U, but is not limited thereto. The output apparatus 30 only needs to be provided at a location where a pressure sensation can be presented to the user U (e.g., arm or leg).

Additionally, the output apparatus 30 for presenting a pressure sensation to the user U has a structure mounted on the fingers F of the user U, but is not limited thereto. For example, in the case of a video game, the output apparatus 30 may be provided on a button of a controller or on the gripping part of the controller. In this case, a physical stimulus can be presented according to the progress in the game by the pressure applied by the user U to the button or gripping part, or the like. Further, the types of pressure sensations presented to the user U include wind pressure, acoustic radiation pressure, electrical stimulus, and the like.

### Determination Apparatus

The determination apparatus 20 includes a detection unit 21, a determination unit 22, an output unit 23, and a storage unit 24. The detection unit 21 detects the shape of the finger F of the user U (e.g., whether the user U is clasping the hand H or opening the hand H), the position of the finger F (e.g., whether the finger F is located in front of the chest of the user U or beside the foot of the user U), the contact area of the finger F of the user U and the stimulus presentation unit 31, and the like. The detection method is not particularly limited. For example, the shape and position of the finger F of the user U may be detected using a sensor such as a camera externally installed, or information about a driving signal may be acquired from the output apparatus 30. Additionally, the determination apparatus 20 may be provided externally and configured to be capable of outputting data to the control apparatus 10 to be described later, or it may be integrated with the control apparatus 10 to be described later.

The determination unit 22 determines a state of a preset action of the user. The preset action of the user refers to, for example, when described in the user U's action of pressing a switch, a user U's action of reaching for the switch to press it, an action of touching the switch (but not pressing it yet), an action being about to press the switch, and an action of pressing the switch (switch-on), an action of removing the hand from the switch, and the like. The determination unit 22 then determines the state of the action of the user U, for example, from the above action examples on the basis of the detection information detected by the detection unit 21.

Additionally, the above-mentioned action may also be, but not limited to the action of pressing the switch as a matter of course, user U's actions such as throwing a ball, hitting a ball, and pressing a button on a controller.

The output unit 23 outputs the result determined by the determination unit 22 described above to the control apparatus 10 to be described later. The means of communication of the output unit 23 is not particularly limited and is wired or wireless (e.g., Wi-Fi (registered trademark) and long term evolution (LTE) ).

The storage unit 24 is constituted by a storage device such as a hard disk or a semiconductor memory. The storage unit 24 stores conditions for determination by the determination unit 22, for example, the state of the user's action described above.

### Control Apparatus

The control apparatus 10 includes an acquisition unit 11, a generation unit 12, a judgment unit 13, an output unit 14, and a storage unit 15. The control apparatus 10 is constituted by a computer (information processing apparatus) including a central processing unit (CPU) and a memory. The memory stores programs and various parameters for having the CPU perform the various functions to be described later. In this embodiment, the control apparatus 10 is mounted on the wrist of the user U via the band B, but of course the present technology is not limited thereto.

Additionally, in this embodiment, the control apparatus 10 is provided separately from the output apparatus 30, but of course the present technology is not limited thereto, and the control apparatus 10 may be provided integrally with the output apparatus 30.

The acquisition unit 11 acquires the determination result output by the determination apparatus 20 described above. Additionally, the acquisition unit 11 also acquires information on the driving signal output from the drive unit 32 to the stimulus presentation unit 31. The means of communication is not particularly limited and is wired or wireless (e.g., Wi-Fi (registered trademark) and long term evolution (LTE) ).

The generation unit 12 generates a driving signal to apply a physical stimulus to the user U according to the state of the user U's action based on the determination result of the determination apparatus 20. Additionally, the generation unit 12 further includes a pattern signal to change the physical stimulus in response to the occurrence of an event to be described later. The above pattern signal includes a third driving signal for applying a third physical stimulus (to be described later) to the user U and a desired physical stimulus change signal (to be described later) for applying a desired physical stimulus change to the user U.

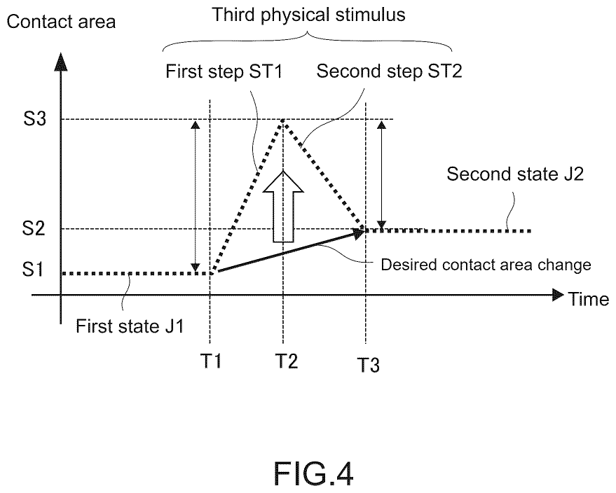

FIG. 4 is a diagram showing changes in a state where a physical stimulus for presenting a pressure sensation is applied to the user U. The generation unit 12 will be described with reference to FIG. 4. Here, a situation where the user U wears virtual reality (VR) goggles and presses a switch in a virtual space with the finger F will be described as an example.

First, for the period up to time T1, when the state of the user U based on the determination result of the determination apparatus 20 is a first state J1 (e.g., the state where the finger F of the user U touches a switch), the generation unit 12 generates a first driving signal to apply a first physical stimulus as a physical stimulus to the user U and outputs the first driving signal to the output apparatus 30. Here, the first physical stimulus refers to a contact stimulus in which the stimulus presentation unit 31 (contact unit) is in contact with the finger F at any pressure in a contact area S1.

Next, for the time after time T3, when the state of the user U based on the determination result of the determination apparatus 20 is a second state J2 (e.g., the state where the finger F of the user U is pressing the switch), the generation unit 12 generates a second driving signal to apply a second physical stimulus as a physical stimulus to the user U and outputs the second driving signal to the output apparatus 30. Here, the second physical stimulus refers to a contact stimulus in which the stimulus presentation unit 31 is in contact with the finger F at any pressure in a contact area S2 (>S1).

For the time from time T1 to time T3, when the state of the user U based on the determination result of the determination apparatus 20 is a third state (e.g., the state where the finger F of the user U is about to press the switch and when the state changes (transitions) from the above first state to the second state), the generation unit 12 generates a third driving signal to apply a third physical stimulus as a physical stimulus to the user U and outputs the third driving signal to the output apparatus 30.

Here, the third physical stimulus refers to a physical stimulus including at least one of an upwardly convex change or a downwardly convex change in the amount of physical stimulus, and the amount of physical stimulus refers to the physical quantity used to present a pressure sensation. In this embodiment, upwardly convex means a change in the amount of physical stimulus (contact area S) that increases and then decreases, and downwardly convex means a change in the amount of physical stimulus (contact area S) that decreases and then increases. The third physical stimulus in FIG. 4 is an upwardly convex change.

Additionally, in this embodiment, the third physical stimulus refers to a physical stimulus (contact stimulus) in which the contact area between the stimulus presentation unit 31 and the finger F of the user U at any pressure changes in the order of the contact area S1, a contact area S3 (>S2), and the contact area S2.

When a desired contact area changes (S2-S1) from the first state J1 to the second state J2, the first state J1 changes to the second state J2 via the third physical stimulus having a first step ST1 and a second step ST2. Such a third state having the first step ST1 and the second step ST2 presents a pressure sensation to the finger F of the user U.

The first step ST1 is the step in which the contact area changes from the contact area S1 to the contact area S3 between time T1 and time T2, and the second step ST2 is the step in which the contact area changes from the contact area S3 to the contact area S2 between time T2 and time T3.

In other words, when the determination apparatus 20 detects, by the detection unit 21, the user U's action being about to press the switch in the virtual space with the finger F, the determination unit 22 determines that the state changes to the second state J2. Such a determination result is output to the control apparatus 10 by the output unit 23. Thus, the control apparatus 10 generates a third driving signal to apply a third physical stimulus. In this embodiment, the physical stimulus changes linearly, but it is not limited thereto and may change smoothly (the first step and the second step change curvilinearly). Additionally, in this embodiment, the third physical stimulus is applied to the user U when the contact area S changes into a different state, i.e., from the first state J1 to the second state J2, but it may be the case where the contact area S does not change (S1=S2) when the state transitions from the first state J1 to the second state J2. Additionally, each of the first step and the second step is not limited to including only one step as in this example, and each step may include a plurality of steps.

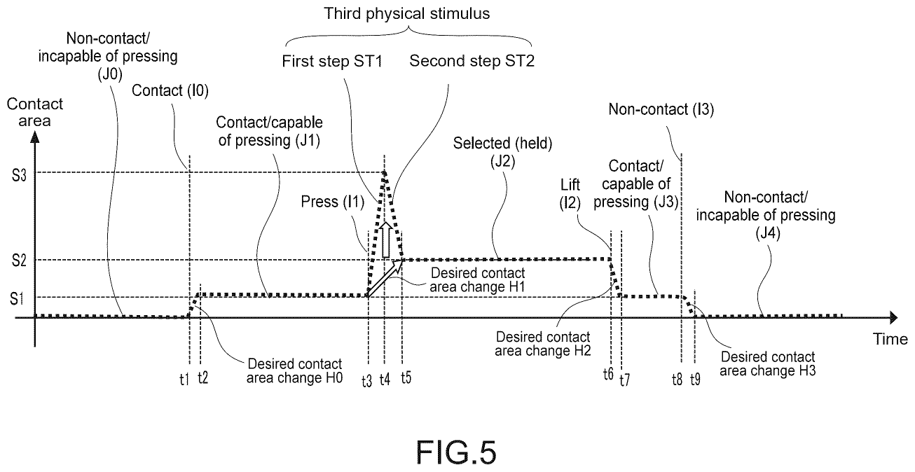

The judgment unit 13 performs various types of judgments regarding generation and output of the pattern signal on the basis of the occurrence of an event. Here, an event is a change in the state (type) of the user U's action and means, for example, contact I0, press I1, lift I2, and non-contact 13 (see FIG. 5). Of course, the events are not limited to those above and may also be a condition in which the finger F of the user U comes close to a switch.

Additionally, various types of judgments mean, for example, that the judgment unit 13 judges whether the state of the user U's action triggers the occurrence of an event, on the basis of the detection information acquired from the detection apparatus 20. Additionally, the judgment unit 13 judges whether to output the above-mentioned pattern signal on the basis of the event information stored in the storage unit 15 to be described later. Further, the judgment unit 13 judges the output status of the above-mentioned pattern signal (whether the output has been completed or is in progress) and the like. Of course, examples of judgments made by the judgment unit 13 are not limited to those judgment examples.

The storage unit 14 is constituted by a storage device such as a hard disk or a semiconductor memory. The storage unit 14 stores information regarding the above-mentioned physical stimulus for presenting a pressure sensation, such as event information.

### Operation of Pressure Sensation Presentation System

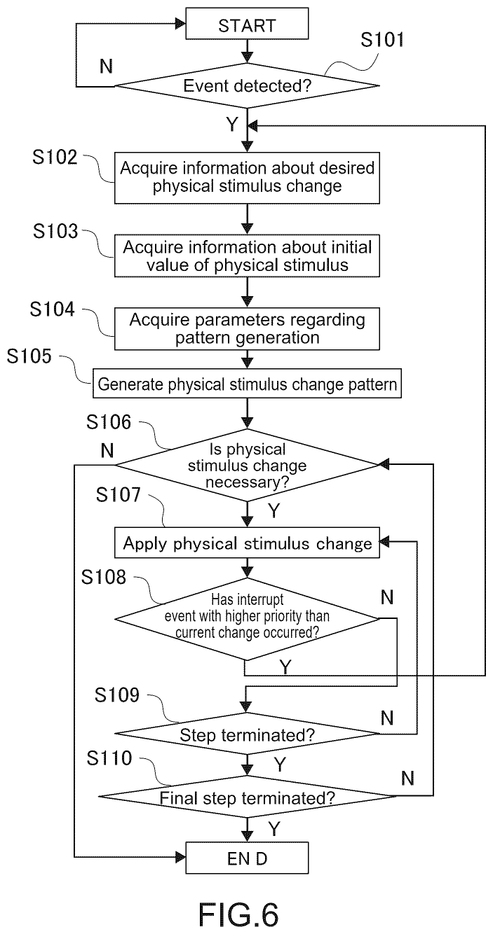

The operation of the pressure sensation presentation system 100 will be described. As a precondition, the pressure sensation presentation system 100 is a system that functions in a situation where a user U wears virtual reality (VR) goggles and presses a switch in a virtual space with a finger F, to generate a driving signal in real time. FIG. 5 is a diagram showing a use example of the pressure sensation presentation system 100 in the first embodiment, and FIG. 6 is a flowchart of the pressure sensation presentation system 100 in the first embodiment.

First, the detection unit 21 detects a position of the finger F of the user U. At that time, for example, if the determination unit 22 determines the first state J1 in which the finger F of the user U is in contact with the switch in the virtual space, the generation unit 12 generates a first driving signal to apply a first physical stimulus (contact stimulus by the contact area S1 with the stimulus presentation unit 31) to the user U, and the output unit 13 outputs the first driving signal to the output apparatus 30.

Next, it is determined whether or not an event has been detected (S101). Here, if the determination unit 22 determines that the event has been detected, the processing proceeds to Step S102. Here, the event detected in the first state J1 is the press I1 shown in FIG. 5. In other words, the determination unit 22 determines whether or not the user U is about to press the switch, and proceeds to Step S102 on the basis of the determination result that the user U is about to press the switch. At that time, whether the user U is about to press the switch is whether the finger F of the user U has moved in the direction toward the switch by a predetermined value or more or whether the contact area with the finger F has changed by a predetermined value or more, which are detected by the detection unit 21, but of course the present technology is not limited thereto.

Next, information about the desired physical stimulus change is acquired (S102). In this embodiment, the physical stimulus change is a contact area change. When the state changes from the state J1 to the state J2 after detection of the event, information about a desired contact area change H1 (S2-S1), which is the change from the contact area S1 in the state J1 stored in the storage unit 24 to the contact area S2 in the state J2, is acquired.

Next, information about the initial value of the physical stimulus is acquired (S103). The acquisition unit 11 acquires information about the driving signal output to the stimulus presentation unit 31 from the output apparatus 30. In this embodiment, the information about the driving signal output to the stimulus presentation unit 31 in the first state J1 is acquired, but the present technology is not limited thereto. The information about the initial value of the physical stimulus may be acquired on the basis of first driving signal information generated by the generation unit 12.

Next, parameters regarding pattern generation are acquired (S104). The acquisition unit 11 acquires information such as vertical fluctuation (e.g., upper limit and lower limit of the contact area), which is at least one of an upwardly convex change or a downwardly convex change in the amount of physical stimulus change for each event stored in the storage unit 15, and the number of steps of the physical stimulus change (e.g., how many times the contact area is increased or decreased).

Next, a pattern signal in which the physical stimulus changes is generated (S105). The generation unit 12 generates a pattern signal on the basis of the information about the desired physical stimulus change described above and the initial value and parameters of the physical stimulus. The pattern signal in this embodiment is a third driving signal to apply a third physical stimulus to the user U when the state changes from the first state J1 to the second state J2. The third physical stimulus in this embodiment has a first step ST1 and a second step ST2. The first step ST1 is the step in which the contact area changes from the contact area S1 to the contact area S3 between time t3 and time t4, and the second step ST2 is the step in which the contact area changes from the contact area S3 to the contact area S2 between time t4 and time t5.

The pattern signal generated may be generated under the following conditions, for example.

For example, if the initial value of the physical stimulus (e.g., contact area S1 in the first state J1) is less than a predetermined value, the amount of physical stimulus change in the first step ST1 is positive, and if it is equal to or greater than a predetermined value, the amount of physical stimulus change in the first step ST1 is negative (first condition). If the value obtained after the physical stimulus changes (e.g., contact area S2 in the second state J2) is less than a predetermined value, the amount of physical stimulus change in the last change step (second step ST2) is negative, and if it is equal to or greater than a predetermined value, the amount of physical stimulus change in the last change step is positive (condition 2). Further, a pattern signal may be generated under the condition in which the conditions 1 and 2 are combined.

Additionally, the pattern signal generated is not limited to the third driving signal. For example, when event 10 occurs, a desired physical stimulus change signal to provide a desired contact area change HO to the user U is generated. The desired physical stimulus change is a change of at least one of an increase or a decrease in the physical stimulus, and is a change in which the value of the physical stimulus does not fluctuate as in the third physical stimulus.

Next, it is determined whether a physical stimulus change is necessary (S106). The judgment unit 13 determines whether a physical stimulus change is necessary, and if so, outputs a pattern signal. In this embodiment, a physical stimulus is necessary (YES) because of the change from the first state J1 to the second state J2. On the other hand, the case of NO in Step S106 is, for example, a case where a physical stimulus is not applied to the user U when an event occurs, such as an event in which the finger F of the user U comes close to a switch.

Next, if a physical stimulus change is necessary in Step S106 (YES in S106), a physical stimulus is applied to the user U (S107). In this embodiment, the third driving signal for applying the third physical stimulus is output to the output apparatus 30 to apply the third physical stimulus to the user U. Here, the time for which the third physical stimulus is applied is roughly within 500 ms, but it is not limited thereto and may be a narrower or wider range of time.

Next, it is detected whether an interrupt event with a higher priority than the physical stimulus change now being given has occurred (S108). If the judgment unit 13 judges that an event with a higher priority has occurred from the determination apparatus 20 during the physical stimulus change, the output of the driving signal of the physical stimulus is interrupted, and the processing proceeds to Step S102 to perform the step for the event with a higher priority. Here, an event with a higher priority is, for example, an event in which the user U interrupts the state of being about to press a switch.

Next, if no interrupt event has occurred in Step S108 (NO in S108), it is judged whether the step has been terminated (S109). For example, it is judged by the judgment unit 13 that the physical stimulus by the first step in the third physical stimulus generated by the generation unit 12 has been output to the user U. Here, the judgment unit 13 may acquire the driving signal information corresponding to the first step from the output apparatus 30 and then judge it.

Next, when judging that the physical stimulus by the first step has been output to the user U (YES in S109), the judgment unit 13 judges whether the final step has been terminated (S110). In this embodiment, in the first step and the second step of the third physical stimulus generated by the generation unit 12, the first step has been output and the second step has not been output (NO in S110), and thus the processing returns to Step S106. If the second step has been output at the time of Step S110 (YES in S110), the flow is terminated.

Thus, the user U can feel the sensation of pressing a switch (pressure sensation) more clearly when the user U performs the action of pressing the switch. Further, it is also possible to present a pressure sensation with a sense of reality to the user U, and to present a sense of immersion in the virtual space to the user U.

Additionally, in this embodiment, a pattern signal in which the physical stimulus changes in real time is generated, but the present technology is not limited thereto, and the pattern signal may be generated in advance (offline). In other words, Steps S102 through S105 may be performed in advance in various patterns to generate pattern signals, and when an event is detected (YES in S101), the pattern signals generated in advance may be acquired. Additionally, for the acquisition of the information about the initial value of the physical stimulus when pattern signals are generated offline, information regarding the initial value may be stored in advance for each event.

### Application Example 1

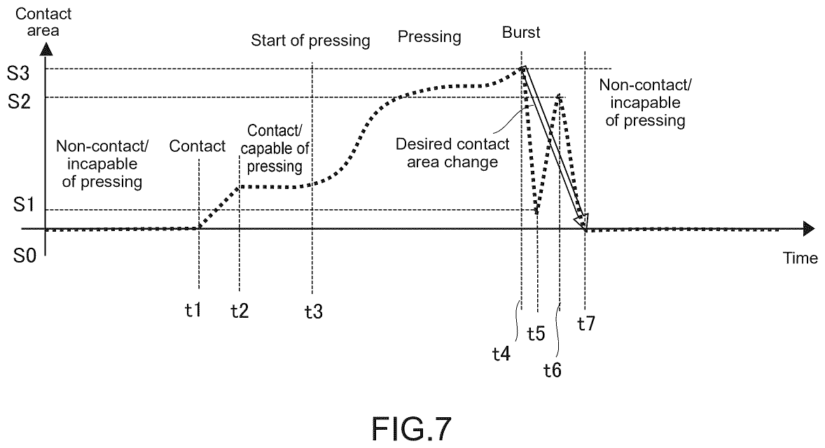

FIG. 7 is a diagram relating to an application example of the pressure sensation presentation system 100 in the first embodiment. Hereinafter, configurations different from those of the first embodiment will be mainly described, and configurations similar to those of the first embodiment will be denoted by similar symbols and the description thereof will be omitted or simplified.

This application example shows a case where the user U holds a balloon in a virtual space and causes it to burst. First, the events in this application example are contact (time t1), start of pressing (time t3), and burst (time t4). For the period from time t1 to time t2 and from time t3 to time t4, the generation unit 12 generates a desired physical stimulus change signal for giving a desired contact area change to the user U.

The desired contact area change is a change of a linear increase in the value of the contact area S from the contact area S0 to the contact area S1 (from time t1 to time t2) and a change of a smooth increase in the value of the contact area S from the contact area S3 to the contact area S4 (from time t3 to time t4).

The third physical stimulus in this application example is the change in contact area S from time t4 to time t7. The third physical stimulus is applied to the user U when the event of burst (t4) occurs. The third physical stimulus has a first step from time t5 to time t6 and a second step from time t4 to time t5 and from time t6 to time t7.

The first step is the change from the contact area S1 to the contact area S2 (from time t5 to time t6), and the second step is the change from the contact area S3 to the contact area S1 (from time t4 to time t5) and from the contact area S2 to the contact area S0 (from time t6 to time t7). The contact area is caused to fluctuate in such a manner, so that the change in contact area can be emphasized to the user U, and a pressure sensation of bursting of the balloon can be presented more clearly. Further, causing the contact area to fluctuate makes it possible to present the impact that occurs when the balloon actually bursts, thus presenting a more realistic pressure sensation to the user U.

### Modified Example 1

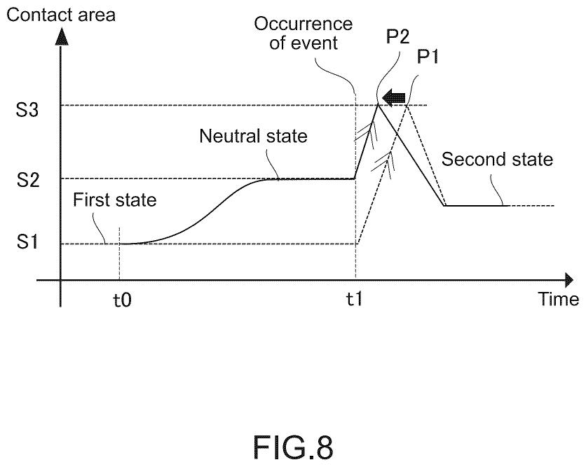

FIG. 8 is a diagram showing a change in state where a physical stimulus is changed before an event occurs. In this modified example, if information on a timing when an event will occur is stored in advance by the storage unit 15, the state may be increased by a predetermined amount from the first state before the event occurs (neutral state). In other words, if the occurrence of an event at time t1 is stored in advance, the first state with the contact area S1 may be changed from time t0 to enter the neutral state with the contact area S2 at time t1.

In such a manner, when the third driving signal is output after the event occurs, if the state changes from the neutral state, a peak P2 of the physical stimulus will be presented to the user U earlier than a peak P1 when the neutral state is not provided. Therefore, the change in pressure sensation can be presented more quickly to the user U, and thus a pressure sensation can be presented more clearly to the user U.

### Modified Example 1-2

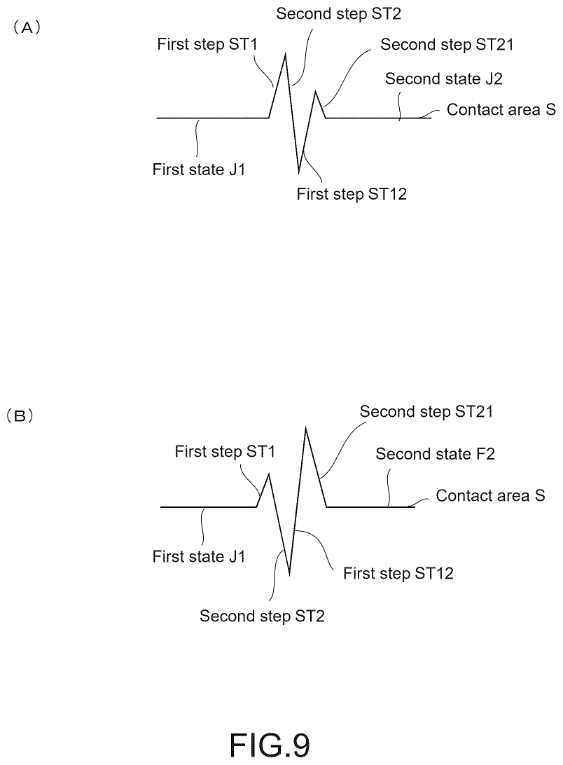

FIG. 9 is a diagram showing patterns of change in contact area S that are presented to the user, in which (A) is a diagram showing a damping pattern, and (B) is a diagram showing an amplification pattern.

As shown in (A) of FIG. 9, in transition from the first state J1 to the second state J2, the amount of change in the contact area S may be reduced such that the amount of change in a first step ST1 (the amount of change in the contact area S in a first step ST1)>the amount of change in a first step ST12 (the amount of change in the contact area S in a first step ST2), and the amount of change in a second step ST2 (the amount of change in the contact area S in a second step ST2)>the amount of change in a second step ST21 (the amount of change in the contact area S in a second step ST21). This makes it possible to present, for example, a pressure sensation of releasing energy or the like or a sensation of a weakening physical stimulus to the user U.

As shown in (B) of FIG. 9, in transition from the first state J1 to the second state J2, the amount of change in the contact area S may be increased such that the amount of change in a first step ST1 (the amount of change in the contact area S in a first step ST1)<the amount of change in a first step ST12 (the amount of change in the contact area S in a first step ST2), and the amount of change in a second step ST2 (the amount of change in the contact area S in a second step ST2)<the amount of change in a second step ST21 (the amount of change in the contact area S in a second step ST21). This makes it possible to present, for example, a sensation of increasing a pressure sensation such as accumulating energy or the like to the user U.

### Second Embodiment

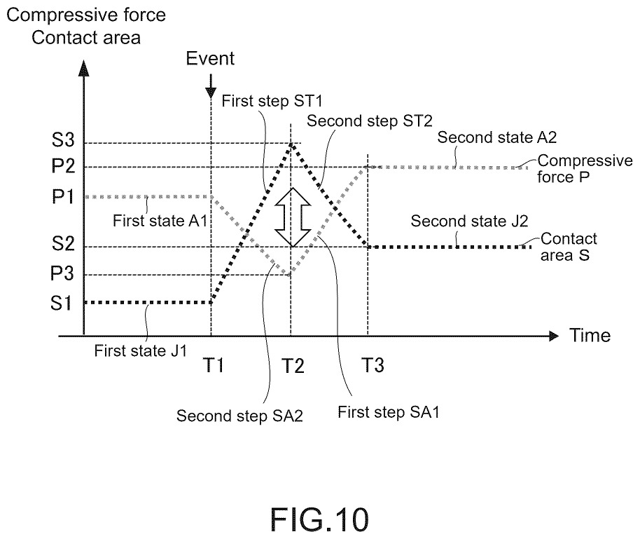

FIG. 10 is a diagram showing changes in a state where a physical stimulus for presenting a pressure sensation and a compressive force is applied to the user U. Hereinafter, configurations different from those of the first embodiment will be mainly described, and configurations similar to those of the first embodiment will be denoted by similar symbols and the description thereof will be omitted or simplified.

This embodiment differs from the first embodiment in that the stimulus presentation unit 31 functions as a compressive force presentation unit that presents a compressive force to the user U.

In other words, the control apparatus 10 and the determination apparatus 20 have the same configurations as in the first embodiment, and the stimulus presentation unit 31 of the output apparatus 30 further has a function as a compressive force presentation unit.

The compressive force presentation unit can apply a predetermined compressive force (pressure) to the user U. The compressive force presentation unit may come into contact with the user U to present a compressive force or may present a compressive force to the user U in a contactless manner (e.g., acoustic radiation pressure or air cannon by ultrasound). The method of controlling the compressive force presentation unit by the drive unit 32 is not particularly limited, but can be controlled by a spring or air pressure, for example.

Additionally, the third physical stimulus can be applied by changing the area to which a compressive force is applied by the compressive force presentation unit. Here, the area to which a compressive force is applied may be either an area in a contactless case or in a contact case (hereinafter, referred to as “compressive area”). Further, the compressive force presentation unit may also function as the contact unit described above. In other words, the compressive force presentation unit may present the compressive force and its area (the contact area presented by the contact unit).

The relationship between the compressive force and the contact area will be described using FIG. 10. Here, description will be given using an example of a situation where the user U wears virtual reality (VR) goggles and presses a switch in a virtual space with the finger F. Additionally, it is assumed that the compressive force presentation unit is in contact with the user and is presenting a compressive force.

First, for the period up to time T1, when the state of the user U based on the determination result of the determination apparatus 20 is a first state J1 and a first state A1 (e.g., the state where the finger F of the user U touches a switch), the generation unit 12 generates a first driving signal to apply a first physical stimulus as a physical stimulus to the user U and outputs the first driving signal to the output apparatus 30. Here, the first physical stimulus refers to a pressure stimulus in which a first pressure P1 is presented to the finger F by a pressure presentation unit and a contact stimulus in which a contact area S1 serving as a compressive area to which a compressive force is applied by the compressive force presentation unit is in contact with the finger F.

Next, for the time after time T3, when the state of the user U based on the determination result of the determination apparatus 20 is a second state J2 and a second state A2 (e.g., the state where the finger F of the user U is pressing the switch), the generation unit 12 generates a second driving signal to apply a second physical stimulus as a physical stimulus to the user U and outputs the second driving signal to the output apparatus 30. Here, the second physical stimulus refers to a pressure stimulus in which a second pressure P2 (>P1) is presented to the finger F by the pressure presentation unit and a contact stimulus in which a contact area S2 (>S1) serving as a compressive area to which a compressive force is applied by the compressive force presentation unit is in contact with the finger F.

For the time from time T1 to time T3, when the state of the user U based on the determination result of the determination apparatus 20 is a third state (e.g., the state where the finger F of the user U is about to press the switch and when the state changes from the first state J1 to the second state J2 and from the first state A1 to the second state A2), the generation unit 12 generates a third driving signal to apply a third physical stimulus as a physical stimulus to the user U and outputs the third driving signal to the output apparatus 30. Here, the third physical stimulus refers to a physical stimulus in which the amount of physical stimulus fluctuates. In this embodiment, the amount of physical stimulus refers to a pressure P applied to the finger F of the user U by the compressive force presentation unit and a contact area S serving as a compressive area to which a compressive force is applied to the finger F of the user U by the compressive force presentation unit.

Additionally, in this embodiment, the third physical stimulus refers to a physical stimulus (contact stimulus) in which the contact area of the compressive force presentation unit with the finger F of the user U changes in the order of the contact area S1, the contact area S3 (>S2), and the contact area S2, and a physical stimulus (pressure stimulus) in which a compressive force to the finger F of the user U by the compressive force presentation unit changes in the order of the compressive force P1, the compressive force P3 (>P2), and the compressive force P2.

When a desired contact area S changes from the first state J1 to the second state J2 (S2-S1), the first state J1 changes to the second state J2 via the third physical stimulus having a first step ST1 and a second step ST2. Such a third state having the first step ST1 and the second step ST2 presents a pressure sensation to the finger F of the user U.

The first step ST1 is the step in which the contact area changes from the contact area S1 to the contact area S3 between time T1 and time T2, and the second step ST2 is the step in which the contact area changes from the contact area S3 to the contact area S2 between time T2 and time T3.

When a desired compressive force changes from the first state A1 to the second state A2 (P2-P1), the first state A1 changes to the second state A2 via the third physical stimulus having a second step SA1 and a first step SA2. Such a third state having the second step SA1 and the first step SA2 presents a compressive force to the finger F of the user U.

Additionally, the first step SA1 is the step in which the compressive force changes from the compressive force P3 to the compressive force P2 between time T2 and time T3, and the second step SA2 is the step in which the compressive force changes from the compressive force P1 to the compressive force P3 between time T1 and time T2.

The change in contact area and the change in compressive force are inversely correlated. In other words, when the contact area increases by the first step ST1, the compressive force decreases by the second step A2, and when the contact area decreases by the second step ST2, the compressive force increases by the first step A1.

Therefore, making the changes in compressive force and contact area inversely correlated makes it possible to present more clearly a pressure sensation to the user U for the action of pressing the switch. In this embodiment, the physical stimulus changes linearly, but the present technology is not limited thereto, and the physical stimulus may change smoothly (the first steps ST1 and SA1 and the second steps ST2 and SA2 change curvilinearly). Of course, the present technology is not limited to the case where the compressive force presentation unit is in contact with the user U as described above, but a compressive force may be presented to the user U in a contactless manner using air pressure, acoustic radiation pressure, or the like.

### Modified Example 2

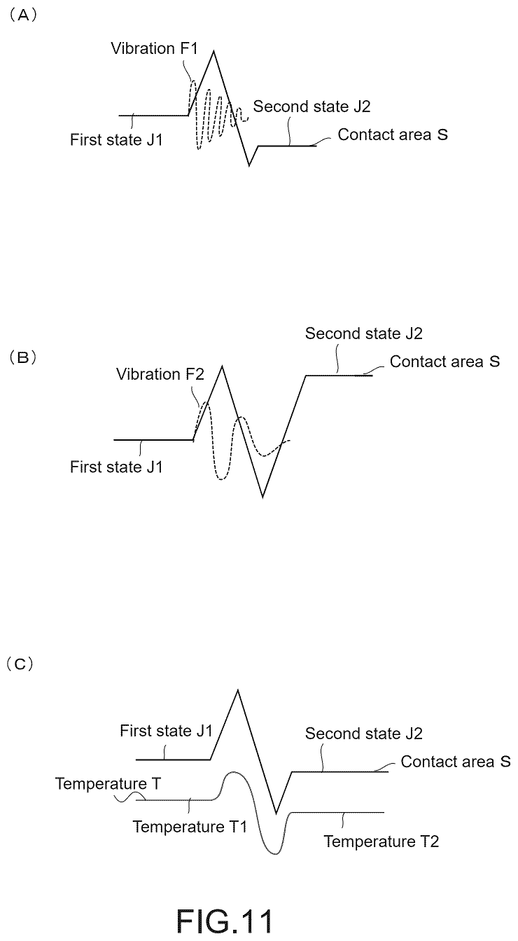

FIG. 11 is a diagram showing patterns to present a pressure sensation to the user U, in which (A) is a diagram showing a pattern of vibration F1 when the contact area S decreases from the first state J1 to the second state J2, (B) is a diagram showing a pattern of vibration F2 when the contact area S increases from the first state J1 to the second state J2, and (C) is a diagram showing a temperature change.

As shown in (A) of FIG. 11, the stimulus presentation unit 31 also has a function as a vibration stimulus unit to apply a vibration stimulus as a physical stimulus to the user U. The vibration stimulus unit can present vibration (or damped vibration) simultaneously with the change in contact area S in response to the amount of change from the first state J1 to the second state J2 (the amount of change in contact area S). Additionally, the frequency of vibration F1 may be changed in accordance with the amount of decrease from the first state J1 to the second state J2. In other words, if the amount of decrease from the first state J1 to the second state J2 is smaller than a predetermined value, the frequency or amplitude can be set to a predetermined value or smaller, or if the amount of decrease from the first state J1 to the second state J2 is a predetermined value or greater, the frequency or amplitude can be set to a predetermined value or greater, thus presenting a pressure sensation using the damped vibration to the user U. For example, if the amount of decrease is smaller than a predetermined value, the frequency (or amplitude) can be set to a predetermined value or smaller to present more clearly a minute change in contact area S (e.g., a sensation of slowly moving away from the hand). Additionally, if the amount of decrease is a predetermined value or greater, the frequency (or amplitude) can be set to a predetermined value or greater to present more clearly a significant change in contact area S (e.g., a bursting sensation).

Additionally, as shown in (B) of FIG. 11, in the case where the amount of change (the amount of change in contact area S) from the first state J1 to the second state J2 increases, if the amount of increase is smaller than a predetermined value, the frequency (e.g., 300 Hz or more) or amplitude can be set to a predetermined range of values, or if the amount of increase from the first state J1 to the second state J2 is a predetermined value or greater, the frequency (e.g., less than 300 Hz) or amplitude can be set to a predetermined range of values, thus presenting a pressure sensation as damped vibration to the user U. For example, if the amount of increase is smaller than a predetermined value, the frequency (or amplitude) can be set to a predetermined range of values to present more clearly a minute change in contact area S (e.g., a sensation of pressing a hard object). Additionally, if the amount of decrease is a predetermined value or greater, the frequency (or amplitude) can be set to a predetermined range of values to present more clearly a significant change in contact area S (e.g., a sensation of pressing a soft object).

Additionally, if the user U touches a hard object, the frequency between 800 Hz and 1000 Hz may be made stronger, and if the user U touches a soft object, the frequency of about 200 Hz may be made stronger. In other words, the frequency of vibration may be varied between 200 Hz and 1000 Hz depending on what the user U touches.

Further, the stimulus presentation unit 31 has a function as a warm sensation presentation unit that applies a warm sensation stimulus as a physical stimulus to the user U. The warm sensation presentation unit can change a temperature T in accordance with the change from the first state J1 to the second state J2. As shown in (C) of FIG. 11, the temperature T can be changed in accordance with the amount of decrease from the first state J1 to the second state J2 (a change from temperature T1 to temperature T2) or in accordance with the amount of increase from the first state J1 to the second state J2. This makes it possible to more clearly present the change in contact area S (a sensation of touching a hot or cold object or leaving from it) to the user U. Here, the warm sensation presentation unit is described assuming that it is in contact with the user U (e.g., Peltier element, etc.) , but of course, it may be a heater or the like that is not in contact with the user U.

### Application Example 2-1

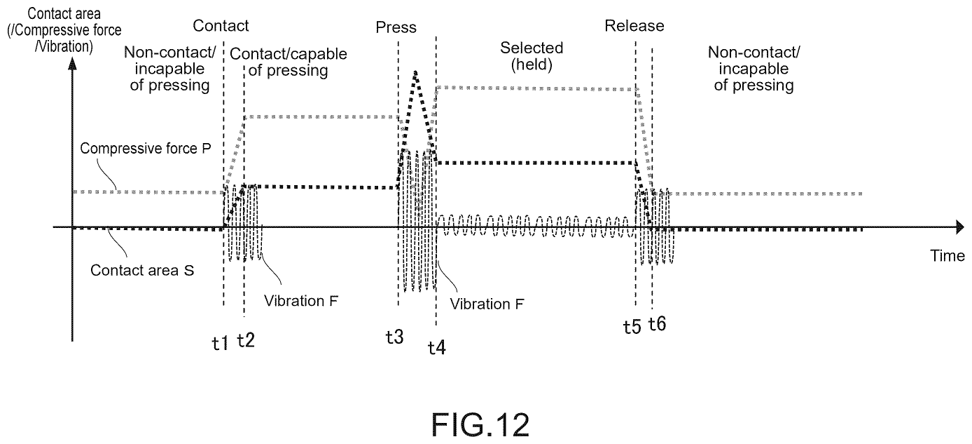

FIG. 12 is a diagram relating to an application example 2-1 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ) .

This application example shows a case where the user U presses a switch in a virtual space. First, events in this application example are contact (time t1), press (time t3), and release (time t4). From time t1 to time t2 and from time t4 to time t5, the generation unit 12 generates a desired physical stimulus change signal for giving a desired contact area change and a desired compressive force change to the user U. Additionally, the generation unit 12 generates a vibration stimulus signal relating to a vibration stimulus between time t1 and time t2, between time t3 and time t4, between time t4 and time t5, and between time t5 and time t6.

Here, the following desired compressive force change refers to a change of an increase or a decrease in the change in physical stimulus and to a change in which the value of the physical stimulus does not fluctuate, like the third physical stimulus.
Additionally, in the case of the desired compressive force change, it increases when the contact area S increases, and it decreases when the contact area S decreases.

In a desired physical stimulus change, for the change in contact area, the value of the contact area S increases from the contact area S1 to the contact area S2 (from time t1 to time t2). In the desired physical stimulus, for the change in compressive force, the value of the compressive force P increases from the compressive force P1 to the compressive force P2 (from time t1 to time t2).
Additionally, for the vibration stimulus, vibration F12 having a predetermined amplitude and frequency is presented from time t1 to time t2. This makes it possible to present a pressure sensation such as contact or release to the user U. Additionally, the contact area S and the compressive force P are not changed from time t4 to time t5, but in order to present a sensation of holding a switch to the user U, vibration F45 having a predetermined amplitude and frequency is presented to the user U.

A third physical stimulus in this application example is applied between time t3 and time t4. The third physical stimulus is applied to the user U when the event of press (t3) occurs.

In the third physical stimulus, for the change in contact area, the value of the contact area S increases to change from the contact area S3 to the contact area S4 (from time t3 to time t4) while fluctuating. In the third physical stimulus, for the change in compressive force, the value of the compressive force P increases to change from the compressive force P3 to the compressive force P4 (from time t3 to time t4) while fluctuating in a relationship inversely correlated with the contact area S.
Additionally, for the vibration stimulus, vibration F34 having a predetermined amplitude and frequency is presented from time t3 to time t4. The contact area S, the compressive force (pressure) P, and the vibration (amplitude, frequency) F are caused to fluctuate in such a manner, so that the change in pressure sensation can be emphasized to the user U, and a pressure sensation of pressing a switch can be presented more clearly. Further, it is also possible to present a pressure sensation with a sense of reality to the user U, and to present a sense of immersion in the virtual space to the user U.

### Application Example 2-2

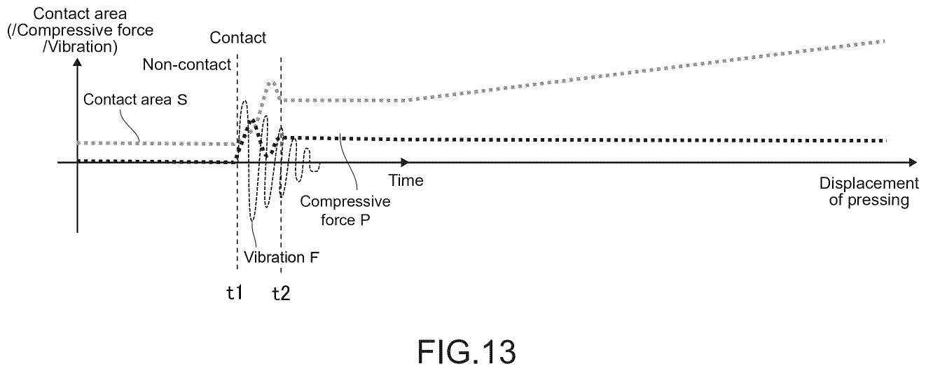

FIG. 13 is a diagram relating to an application example 2 -2 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ) .

This application example shows a case where the user U grabs a hard object and press it in a virtual space. First, an event in this application example is contact (time t1). A third physical stimulus in this application example is applied between time t1 and time t2. The third physical stimulus is applied to the user U when the event of contact (time t1) occurs. Additionally, a vibration stimulus signal regarding a vibration stimulus is generated from time t1 to time t2.

In the third physical stimulus, for the change in contact area, the value of the contact area S increases to change from the contact area S1 to the contact area S2 (from time t1 to time t2) while fluctuating. In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, for the vibration stimulus, vibration F12 having a predetermined amplitude and frequency is damped from time t1 to time t2.

The contact area S and the compressive force (pressure) P are caused to fluctuate in such a manner to be damped at a predetermined frequency (e.g., 800 Hz or more and 1000 Hz or less), so that the change in pressure sensation can be emphasized to the user U, and a pressure sensation of grabbing a hard object can be presented more clearly. Additionally, when the user U grabs a hard object and press it, the contact area S does not change to a large extent, but the compressive force P increases with a certain amount of change. This makes it possible to present a sensation that a hard object is difficult to press to the user U with a sense of reality.

### Application Example 2-3

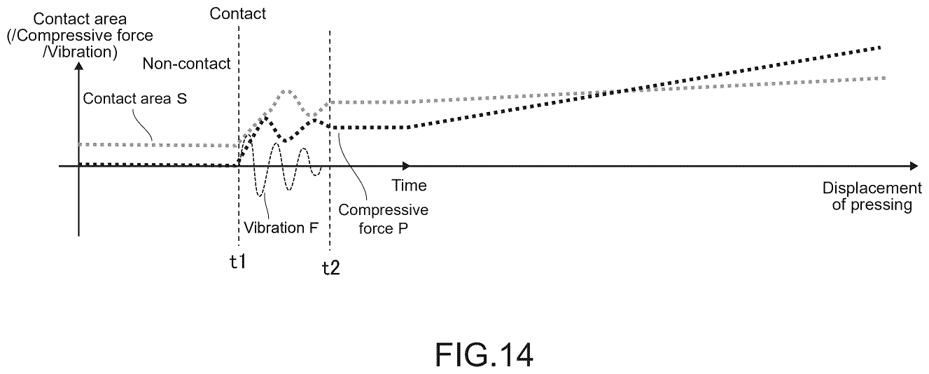

FIG. 14 is a diagram relating to an application example 2-3 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ) .

This application example shows a case where the user U grabs a soft object and press it in a virtual space. First, an event in this application example is contact (time t1). A third physical stimulus in this application example is applied between time t1 and time t2. The third physical stimulus is applied to the user U when the event of contact (time t1) occurs. Additionally, a vibration stimulus signal regarding a vibration stimulus is generated from time t1 to time t2.

In the third physical stimulus, for the change in contact area, the value of the contact area S increases to change from the contact area S1 to the contact area S2 (from time t1 to time t2) while fluctuating. In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, for the vibration stimulus, vibration F12 having a predetermined amplitude and frequency is damped from time t1 to time t2.

The contact area S and the compressive force (pressure) P are caused to fluctuate in such a manner to be damped at a predetermined frequency (e.g., approximately 200 Hz), so that the change in pressure sensation can be emphasized to the user U, and a pressure sensation of grabbing a soft object can be presented more clearly. Additionally, when the user U grabs a soft object and press it, the contact area S increases with a larger amount of change than the compressive force P. This makes it possible to present a sensation that a soft object is easy to press to the user U with a sense of reality.

### Application Example 2-4

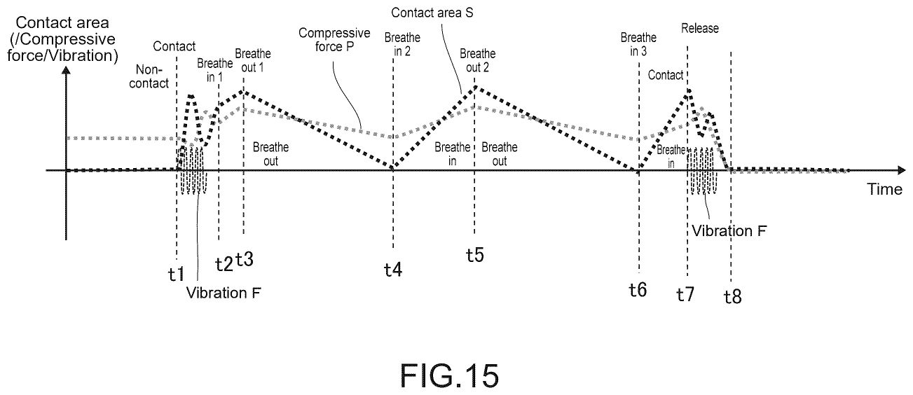

FIG. 15 is a diagram relating to an application example 2-4 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ) .

This application example shows a case where the user U grabs a creature moving and breathing at, for example, approximately 1 Hz to 20 Hz in a video game or in a virtual space. First, events in this application example are contact (time t1), breathe in 1 (time t2), breathe out 1 (time t3), breathe in 2 (time t4), breathe out 2 (time t5), breathe in 3 (time t6), and release (time t7). From time t2 to time t3, from time t3 to time t4, from time t4 to time t5, from time t5 to time t6, and from time to to time t7, the generation unit 12 generates a desired physical stimulus change signal for giving a desired contact area change and a desired compressive force change to the user U. Additionally, the generation unit 12 generates a vibration stimulus signal relating to a vibration stimulus between time t1 and time t2, and between time t7 and time t8.

In the desired physical stimulus change, for the change in contact area, the value of the contact area S increases from the contact area S2 to the contact area S3 (from time t2 to time t3), from the contact area S4 to the contact area S5 (from time t4 to time t5), and from the contact area S6 to the contact area S7 (from time t6 to time t7). Additionally, the value of the contact area S decreases from the contact area S3 to the contact area S4 (from time t3 to time t4), and from the contact area S5 to the contact area S6 (from time t5 to time t6).

In the desired physical stimulus, for the change in compressive force, the value of the compressive force P increases from the compressive force P2 to the compressive force P3 (from time t2 to time t3), from the compressive force P4 to the compressive force P5 (from time t4 to time t5), and from the compressive force P6 to the compressive force P7 (from time t6 to time t7). Additionally, the value of the compressive force P decreases from the compressive force P3 to the compressive force P4 (from time t3 to time t4) and from the compressive force P5 to the compressive force P6 (from time t5 to time t6).

This makes it possible to present a sensation that a creature is breathing to the user U.

A third physical stimulus in this application example is applied between time t1 and time t2 and between time t7 and time t8. The third physical stimulus is applied to the user U when the events of contact (time t1 ) and release (time t7) occur.

In the third physical stimulus, for the change in contact area, the value of the contact area S increases to change from the contact area S1 to the contact area S2 (from time t1 to time t2) while fluctuating. Additionally, the value of the contact area S decreases to change from the contact area S7 to the contact area S8 (from time t7 to time t8) while fluctuating.

In the third physical stimulus, for the change in compressive force, the value of the compressive force P increases to change from the compressive force P1 to the compressive force P2 (from time t1 to time t2) while fluctuating in a relationship inversely correlated with the contact area S.

Additionally, the value of the compressive force P decreases to change from the compressive force P7 to the compressive force P8 (from time t7 to time t8) while fluctuating in a relationship inversely correlated with the contact area S.

In this embodiment, the generation unit 12 further generates a vibration stimulus signal for presenting a vibration stimulus in addition to the third physical stimulus. For the vibration stimulus, vibration F12 and vibration F78 each having a predetermined amplitude and frequency are presented from time t1 to time t2 and from time t7 to time t8.

The contact area S and the compressive force (pressure) P are caused to fluctuate in such a manner to present predetermined vibration (amplitude, frequency) F, so that the change in pressure sensation can be emphasized to the user U, and a pressure sensation of grabbing a breathing creature can be presented more clearly. Further, it is possible to present a pressure sensation with a sense of reality to the user U, and to present a sense of immersion in the video game or virtual space to the user U.

### Application Example 2-5

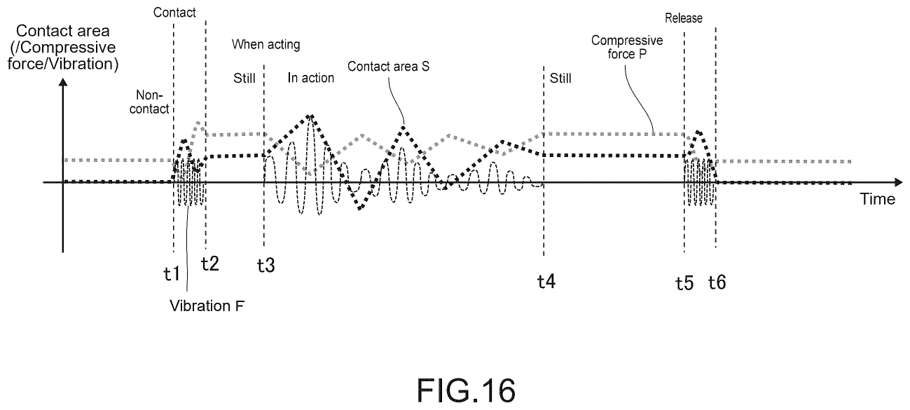

FIG. 16 is a diagram relating to an application example 2-5 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ).

This application example shows a case where the user U grabs a writhing creature moving at, for example, approximately 1 Hz to 20 Hz in a video game or in a virtual space. First, events in this application example are contact (time t1), when acting (time t3), and release (time t5). A third physical stimulus in this application example is applied from time t1 to time t2, from time t3 to time t4, and from time t5 to time t6. The third physical stimulus is applied to the user U when the events of contact (time t1), when acting (time t3), and release (time t7) occur.
Additionally, a vibration stimulus signal regarding a vibration stimulus is generated from time t1 to time t2, and from time t5 to time t6.

In the third physical stimulus, for the change in contact area, the value of the contact area S increases to change from the contact area S1 to the contact area S2 (from time t1 to time t2) while fluctuating. Additionally, the value of the contact area S transitions from the contact area S3 (time t3) to the contact area S4 (S3=S4, time t4) while fluctuating. Additionally, the value of the contact area S decreases to change from the contact area S5 to the contact area S6 (from time t5 to time t6) while fluctuating.

In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, the value of the compressive force P transitions from the compressive force P3 (time t3) to the compressive force P4 (P3=P4, time t4) while fluctuating. Additionally, the value of the compressive force P decreases to change from the compressive force P3 to the compressive force P4 (from time t3 to time t4) while fluctuating in a relationship inversely correlated with the contact area S.

In this embodiment, the generation unit 12 further generates a vibration stimulus signal for presenting a vibration stimulus in addition to the third physical stimulus. For the vibration stimulus, vibration F12 and vibration F56 each having a predetermined amplitude and frequency are presented from time t1 to time t2 and from time t5 to time t6. Additionally, vibration F34 in which the amplitude value varies is presented from time t3 and time t4.

When the amplitude value increases from time t3 to time t4, the value of the contact area S increases, and when the amplitude value decreases, the value of the contact area S also decreases. This makes it possible to present a sensation that the creature is writhing to the user with a sense of reality.

The contact area S and the compressive force (pressure) P are caused to fluctuate in such a manner to present predetermined vibration (amplitude, frequency) F, so that the change in pressure sensation can be emphasized to the user U, and a pressure sensation of grabbing a writhing creature can be presented more clearly. Further, it is possible to present a pressure sensation with a sense of reality to the user U, and to present a sense of immersion in the video game or virtual space to the user U.

### Application Example 2-6

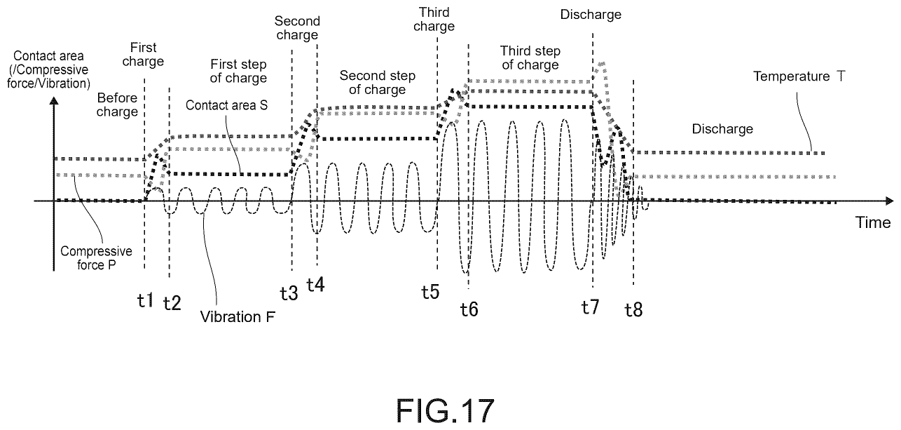

FIG. 17 is a diagram relating to an application example 2-6 in which a pressure sensation is presented to the user U by using a contact area S, a compressive force P, vibration F, and a temperature T. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ) , the value of the compressive force P at time t is represented as Pt (t=1, 2, 3. . . ) , the value of the vibration F from time t to t+1 is represented as Ft, t+1 (t=1, 2, 3 . . . ) , and the value of the temperature T at time t is represented as Tt (t=1, 2, 3 . . . ) .

This application example shows a case where the user U stores energy in the user U's hand and releases the energy in a video game or in a virtual space. First, events in this application example are first charge (time t1), second charge (time t3), third charge (time t5), and discharge (time t7). A third physical stimulus in this application example is applied from time t1 to time t2, from time t3 to time t4, from time t5 to time t6, and from time t7 to time t8. The third physical stimulus is applied to the user U when the events of first charge (time t1), second charge (time t3), third charge (time t5), and discharge (time t7) occur. Additionally, a vibration stimulus signal regarding a vibration stimulus is generated from time t1 to time t2, from time t2 to time t3, from time t3 to time t4, from time t4 to time t5, from time t5 to time t6, from time t6 to time t7, and from time t7 to time t8. Additionally, a temperature stimulus signal regarding a temperature stimulus is generated from time t1 to time t2, from time t2 to time t3, from time t3 to time t4, from time t4 to time t5, from time t5 to time t6, from time t6 to time t7, and from time t7 to time t8.

In the third physical stimulus, for the change in contact area, the value of the contact area S increases to change from the contact area S1 to the contact area S2 (from time t1 to time t2) while fluctuating. Additionally, the value of the contact area S increases to change from the contact area S3 to the contact area S4 (from time t3 to time t4) while fluctuating. Additionally, the value of the contact area S increases to change from the contact area S5 to the contact area S6 (from time t5 to time t6) while fluctuating. Additionally, the value of the contact area S decreases to change from the contact area S7 to the contact area S8 (from time t7 to time t8) while fluctuating. This makes it possible to present, to the user U, a sensation that the magnitude of the charged energy is changed or the energy is released.

In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, the value of the compressive force P increases to change from the compressive force P3 to the compressive force P4 (from time t3 to time t4) while fluctuating in a relationship inversely correlated with the contact area S. Additionally, the value of the compressive force P increases to change from the compressive force P5 to the compressive force P6 (from time t5 to time t6) while fluctuating in a relationship inversely correlated with the contact area S. Additionally, the value of the compressive force P decreases to change from the compressive force P7 to the compressive force P8 (from time t7 to time t8) while fluctuating in a relationship inversely correlated with the contact area S. This makes it possible to present, to the user U, a sensation that the magnitude of the charged energy is changed or the energy is released.

In this embodiment, the generation unit 12 further generates a vibration stimulus signal for presenting a vibration stimulus in addition to the third physical stimulus. For the vibration stimulus, vibration F12 having a predetermined amplitude and frequency is presented from time t1 to time t2.
Additionally, vibration F34 having a predetermined amplitude and frequency (>amplitude of vibration F12) is presented from time t3 and time t4. Additionally, vibration F56 having a predetermined amplitude and frequency (>amplitude of vibration F34) is presented from time t5 to time t6. Additionally, vibration F78 having a predetermined amplitude and frequency and being damped is presented from time t7 to time to. Here, for example, the amplitude of vibration F12 is maintained in order to present to the user U the sensation that the energy of vibration F23 (from time t2 to time t3) is charged by one stage. The same applies to vibration F45 and vibration F67. For vibration F78, damped vibration is presented in order to present to the user U the sensation that the energy is released.

In this embodiment, the generation unit 12 further generates a temperature stimulus signal for presenting a temperature stimulus in addition to the third physical stimulus. For the temperature change, the value of the temperature T increases to change from temperature T1 to temperature T2 (from time t1 to time t2). Additionally, the value of the temperature T increases to change from temperature T3 to temperature T4 (from time t3 to time t4). Additionally, the value of the temperature T increases to change from temperature T5 to temperature T6 (from time t5 to time t6). Additionally, the value of the temperature T decreases to change from temperature T7 to temperature T8 (from time t7 to time t8). Changing the temperature in such a manner makes it possible to present a sensation of storing the energy or a sensation of releasing the energy to the user U by using the temperature change.

The contact area S and the compressive force (pressure) P are caused to fluctuate in such a manner to present predetermined vibration (amplitude, frequency) F and temperature T, so that the change in pressure sensation can be emphasized to the user U, and a pressure sensation of charging and releasing the energy can be presented more clearly. Further, it is possible to present a pressure sensation with a sense of reality to the user U, and to present a sense of immersion in the video game or virtual space to the user U.

### Application Example 2-7

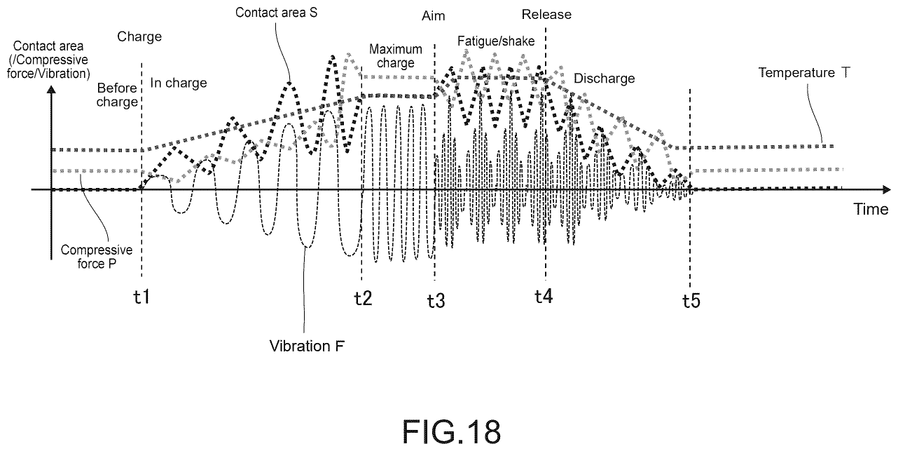

FIG. 18 is a diagram relating to an application example 2-7 in which a pressure sensation is presented to the user U by using a contact area S, a compressive force P, vibration F, and a temperature T. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ) , the value of the compressive force P at time t is represented as Pt (t=1, 2, 3 . . . ) , the value of the vibration F from time t to t+1 is represented as Ft, t+1 (t=1, 2, 3 . . . ) , and the value of the temperature T at time t is represented as Tt (t=1, 2, 3 . . . ) .

This application example shows a case where the user U releases an arrow in a video game or in a virtual space. First, events in this application example are charge (time t1), aim (time t3), and release (time t4). A third physical stimulus in this application example is applied from time t1 to time t2, from time t3 to time t4, and from time t5 to time t6. The third physical stimulus is applied to the user U when the events of charge (time t1), aim (time t3), and release (time t4) occur. Additionally, a vibration stimulus signal regarding a vibration stimulus is generated from time t1 to time t2, from time t2 to time t3, from time t3 to time t4, and from time t4 to time t5. Additionally, a temperature stimulus signal regarding a temperature stimulus is generated from time t1 to time t2, from time t2 to time t3, from time t3 to time t4, and from time t4 to time t5.

In the third physical stimulus, for the change in contact area, the value of the contact area S increases to change from the contact area S1 to the contact area S2 (from time t1 to time t2) while fluctuating. Additionally, the value of the contact area S transitions from the contact area S3 (time t3) to the contact area S4 (S3=S4, time t4) while fluctuating. Additionally, the value of the contact area S decreases to change from the contact area S4 to the contact area S5 (from time t4 to time t5) while fluctuating.

In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, the value of the compressive force P transitions from the compressive force P3 (time t3) to the compressive force P4 (P3=P4, time t4) while fluctuating. Additionally, the value of the compressive force P decreases to change from the compressive force P4 to the compressive force P5 (from time t4 to time t5) while fluctuating in a relationship inversely correlated with the contact area S.

In this embodiment, the generation unit 12 further generates a vibration stimulus signal for presenting a vibration stimulus in addition to the third physical stimulus. For the vibration stimulus, the amplitude of the vibration F12 changes while increasing from time t1 to time t2. The value of the amplitude of the vibration F34 repeatedly increases and decreases from time t3 to time t4. The amplitude of vibration F45 is damped while repeatedly increasing and decreasing from time t4 to time t5. Here, for example, the amplitude of vibration F12 is maintained in order to present to the user U a sensation that the energy of vibration F23 (from time t2 to time t3) is charged by one stage. For vibration F78, damped vibration is presented in order to present a sensation of releasing the energy.

In this embodiment, the generation unit 12 further generates a temperature stimulus signal for presenting a temperature stimulus in addition to the third physical stimulus. For the temperature change, the value of the temperature T increases to change from temperature T1 to temperature T2 (from time t1 to time t2). Additionally, the value of the temperature T decreases to change from temperature T4 to temperature T5 (from time t4 to time t5). Changing the temperature in such a manner makes it possible to present a sensation of drawing the bow or a sensation of releasing the arrow to the user U by using the temperature change.

Increasing the contact area S, the compressive force P, the vibration F, and the temperature T from time t1 to time t2 makes it possible to present a sensation of drawing the bow to the user U. Additionally, it is possible to present, to the user U, a sensation that the bow has been fully drawn from time t2 to time t3, a sensation of aiming and swaying slightly due to the fluctuation of the contact area S, the compressive force P, the vibration F from time t3 to time t4, and a sense of fatigue due to aiming.

Additionally, it is possible to present a shake caused when the arrow is released, by changing the contact area S, the compressive force P, the vibration F, and the temperature T while being decreased, from time t2 to time t5.

The contact area S and the compressive force (pressure) P are caused to fluctuate in such a manner to present predetermined vibration (amplitude, frequency) F and temperature T, so that the change in pressure sensation can be emphasized to the user U, and a pressure sensation of drawing the bow and releasing the arrow can be presented more clearly. Further, it is possible to present a pressure sensation with a sense of reality to the user U, and to present a sense of immersion in the video game or virtual space to the user U.

### Application Example 2-8

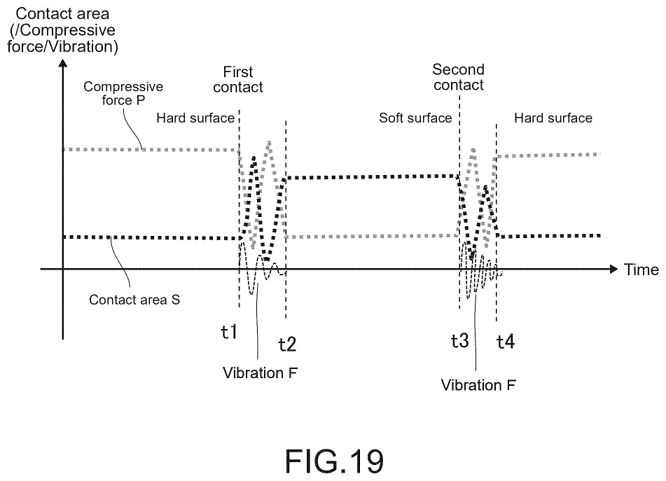

FIG. 19 is a diagram relating to an application example 2-8 in which a pressure sensation is presented to the user U by using a contact area S, a compressive force P, and vibration F. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ) , and the value of the vibration F from time t to t+1 is represented as Ft, t+1 (t=1, 2, 3 . . . ).

This application example shows a case where the user U traces surfaces of different materials in a virtual space. First, events in this application example are first contact (time t1) and second contact (time t3). A third physical stimulus in this application example is applied from time t1 to time t2 and from time t3 to time t4. The third physical stimulus is applied to the user U when the events of first contact (time t1) and second contact (time t3) occur. Additionally, a vibration stimulus signal regarding a vibration stimulus is generated from time t1 to time t2, from time t2 to time t3, and from time t3 to time t4.

In the third physical stimulus, for the change in contact area, the value of the contact area S increases to change from the contact area S1 to the contact area S2 (from time t1 to time t2) while fluctuating. Additionally, the value of the contact area S decreases to change from the contact area S3 to the contact area S4 (from time t3 to time t4) while fluctuating.

In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, the value of the compressive force P decreases to change from the compressive force P3 to the compressive force P4 (from time t3 to time t4) while fluctuating in a relationship inversely correlated with the contact area S.

In this embodiment, the generation unit 12 further generates a vibration stimulus signal for presenting a vibration stimulus in addition to the third physical stimulus. For the vibration change, the vibration F12 is damped from time t1 to time t2. The vibration F34 is damped from time t3 to time t4. Here, increasing the frequency of the vibration F34 to be higher than the frequency of the vibration F12 makes it possible to present a sensation of touching a hard object.

The contact area S and the compressive force (pressure) P are caused to fluctuate in such a manner to present predetermined vibration (amplitude, frequency) F, so that the change in pressure sensation can be emphasized to the user U, and a pressure sensation of tracing surfaces of different materials can be presented more clearly. Further, it is possible to present a pressure sensation with a sense of reality to the user U, and to present a sense of immersion in the virtual space to the user U.

### Application Example 2-9

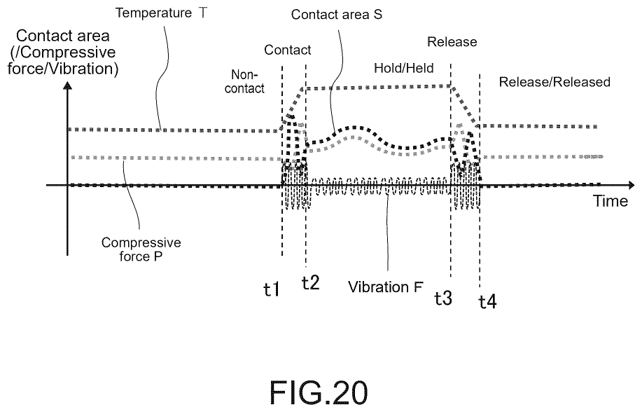

FIG. 20 is a diagram relating to an application example 2-9 in which a pressure sensation is presented to the user U by using a contact area S, a compressive force P, vibration F, and temperature T. Hereinafter, configurations different from those of the first embodiment and the second embodiment will be mainly described, and configurations similar to those of the first embodiment and the second embodiment will be denoted by similar symbols and the description thereof will be omitted or simplified. Additionally, hereinafter, the value of the contact area S at time t is represented as St (t=1, 2, 3 . . . ), the value of the compressive force P at time t is represented as Pt (t=1, 2, 3 . . . ), the value of the vibration F from time t to t+1 is represented as Ft, t+1 (t=1, 2, 3 . . . ), and the value of the temperature T at time t is represented as Tt (t=1, 2, 3 . . . ).

This application example shows a case where the user U holds hands with a human in a virtual space. First, events in this application example are contact (time t1) and release (time t3). A third physical stimulus in this application example is applied from time t1 to time t2 and from time t3 to time t4. From time t2 to time t3, the generation unit 12 generates a desired physical stimulus change signal for giving a desired contact area change and a desired compressive force change to the user U. Additionally, a vibration stimulus signal regarding a vibration stimulus is generated from time t1 to time t2, from time t2 to time t3, and from time t3 to time t4. Additionally, a temperature stimulus signal regarding a temperature stimulus is generated from time t1 to time t2, from time t2 to time t3, and from time t3 to time t4.

In the desired physical stimulus change, for the change in contact area, the value of the contact area S fluctuates from the contact area S2 to the contact area S3 (S2=S3, from time t2 to time t3). In the desired physical stimulus, for the change in compressive force, the value of the compressive force P fluctuates from the compressive force P2 to the compressive force P3 (P2=P3, from time t2 to time t3),

In the third physical stimulus, for the change in contact area, the value of the contact area S increases to change from the contact area S1 to the contact area S2 (from time t1 to time t2) while fluctuating. Additionally, the value of the contact area S decreases to change from the contact area S3 to the contact area S4 (from time t3 to time t4) while fluctuating.

In the third physical stimulus, for the change in compressive force, the value of the compressive force P increases to change from the compressive force P1 to the compressive force P2 (from time t1 to time t2) while fluctuating in a relationship inversely correlated with the contact area S.
Additionally, the value of the compressive force P decreases to change from the compressive force P3 to the compressive force P4 (from time t3 to time t4) while fluctuating in a relationship inversely correlated with the contact area S.

In the third physical stimulus, for the change in vibration, the vibration F12 from time t1 to time t2 and the vibration F34 from time t3 to time t4 vibrate at a predetermined amplitude and frequency. The amplitude of the vibration F23 from time t2 to time t3 is smaller than that of the vibration F12 and the vibration F34.

In the third physical stimulus, for the change in temperature, the value of the temperature T increases to change from the temperature T1 to the temperature T2 (from time t1 to time t2). Additionally, the value of the temperature T decreases to change from the temperature T3 to the temperature T4 (from time t3 to time t4). Changing the temperature in such a manner makes it possible to present a sensation of holding hands or a sensation of releasing hands to the user U by using the change in temperature.

The contact area S and the compressive force (pressure) P are caused to fluctuate in such a manner to present predetermined vibration (amplitude, frequency) F, so that the change in pressure sensation can be emphasized to the user U, and a sensation of holding hands or releasing hands can be presented more clearly. Further, it is possible to present a pressure sensation with a sense of reality to the user U, and to present a sense of immersion in the virtual space to the user U.

The configurations of the pressure sensation presentation system, the control apparatus, and the like that have been described hereinabove with reference to the drawings are merely embodiments and can be discretionally modified without departing from the gist of the present technology. In other words, any other configurations for implementing the present technology may be employed.

Note that the present technology can have the following configurations.

(1) A pressure sensation presentation system, including:
an output apparatus that applies a physical stimulus for presenting a pressure sensation to a user;
a determination apparatus that determines a state of a preset action of the user; and
a control apparatus including a generation unit that generates
   a first driving signal to apply a first physical stimulus to the user when the state of the action is a first state,
   a second driving signal to apply a second physical stimulus to the user when the state of the action is a second state, and
   a third driving signal to apply a third physical stimulus to the user in a transition from the first state to the second state, the third physical stimulus including at least one of an upwardly convex change or a downwardly convex change in an amount of physical stimulus.

(2) The pressure sensation presentation system according to (1), in which
the second physical stimulus is different from the first physical stimulus.

(3) The pressure sensation presentation system according to (1) or (2), in which
the third physical stimulus includes, during the transition from the first state to the second state,
   a first step in which the amount of physical stimulus increases, and
   a second step including a second step in which the amount of physical stimulus decreases.

(4) The pressure sensation presentation system according to any one of (1) to (3), in which
the output apparatus includes a contact unit that comes into contact with the user, and
the output apparatus applies a contact stimulus as the physical stimulus between the user and the contact unit.

(5) The pressure sensation presentation system according to any one of (1) to (4), in which
the output apparatus includes a compressive force presentation unit that applies a compressive force as the physical stimulus to the user.

(6) The pressure sensation presentation system according to (5), in which
the third physical stimulus includes a step in which a contact area between the user and the contact unit that changes an area to which the compressive force is applied by the compressive force presentation unit increases and the compressive force decreases, and a step in which the contact area decreases and the compressive force increases.

(7) The pressure sensation presentation system according to (6), in which
the control unit changes a compressive area in which the user and the compressive force presentation unit are in contact with each other.

(8) The pressure sensation presentation system according to (6), in which
the third physical stimulus includes
   a step in which the area to which the compressive force is applied to the user by the compressive force presentation unit increases and the compressive force decreases, and
   a step in which the area to which the compressive force is applied to the user by the compressive force presentation unit decreases and the compressive force increases.

(9) The pressure sensation presentation system according to (7), in which
the third physical stimulus includes
   a step in which the compressive area increases and the compressive force decreases, and
   a step in which the compressive area decreases and the compressive force increases.

(10) The pressure sensation presentation system according to any one of (1) to (9), in which
the output apparatus includes a vibration presentation unit that applies a vibration stimulus as the physical stimulus to the user.

(11) The pressure sensation presentation system according to (10), in which
the vibration stimulus is a damped vibration.

(12) The pressure sensation presentation system according to (10) or (11), in which
the vibration stimulus includes a frequency component of 200 Hz or more and 1000 Hz or less.

(13) The pressure sensation presentation system according to any one of (1) to (12), in which
the output apparatus further includes a warm sensation presentation unit that applies a warm sensation stimulus as the physical stimulus to the user.

(14) The pressure sensation presentation system according to (13), in which
the warm sensation presentation unit comes into contact with the user, and
the control unit changes a contact area in which the warm sensation presentation unit is in contact with the user when the warm sensation stimulus is applied to the user by the warm sensation presentation unit.

(15) The pressure sensation presentation system according to (3), in which
the third physical stimulus includes a plurality of the first steps and a plurality of the second steps.

(16) A control apparatus, including
a generation unit that generates, on the basis of a determination result of a determination apparatus that determines a state of a preset action of the user, for an output apparatus that applies a physical stimulus for presenting a pressure sensation to the user,
   a first driving signal to apply a first physical stimulus to the user when the state of the action of the user is a first state,
   a second driving signal to apply a second physical stimulus to the user when the state of the action is a second state, and
   a third driving signal to apply a third physical stimulus to the user in a transition from the first state to the second state, the third physical stimulus including at least one of an upwardly convex change or a downwardly convex change in an amount of physical stimulus.

### Reference Signs List

10 control apparatus
11 acquisition unit
12 generation unit
13 judgment unit
14 output unit
15 storage unit
20 determination apparatus
21 detection unit
22 determination unit
23 output unit
24 storage unit
30 output apparatus
31 stimulus presentation unit
32 drive unit
100 pressure sensation presentation system
200 casing
201 opening surface
U user
F finger
S contact area

1. A pressure sensation presentation system, comprising:
an output apparatus that applies a physical stimulus for presenting a pressure sensation to a user;
a determination apparatus that determines a state of a preset action of the user; and
a control apparatus including a generation unit that generates
a first driving signal to apply a first physical stimulus to the user when the state of the action is a first state,
a second driving signal to apply a second physical stimulus to the user when the state of the action is a second state, and
a third driving signal to apply a third physical stimulus to the user in a transition from the first state to the second state, the third physical stimulus including at least one of an upwardly convex change or a downwardly convex change in an amount of physical stimulus.

2. The pressure sensation presentation system according to claim 1, wherein
the second physical stimulus is different from the first physical stimulus.

3. The pressure sensation presentation system according to claim 1, wherein
the third physical stimulus includes, during the transition from the first state to the second state,
a first step in which the amount of physical stimulus increases, and
a second step in which the amount of physical stimulus decreases.

4. The pressure sensation presentation system according to claim 1, wherein
the output apparatus includes a contact unit that comes into contact with the user, and
the output apparatus applies a contact stimulus as the physical stimulus between the user and the contact unit.

5. The pressure sensation presentation system according to claim 1, wherein
the output apparatus includes a compressive force presentation unit that applies a compressive force as the physical stimulus to the user.

6. The pressure sensation presentation system according to claim 5, wherein
the third physical stimulus changes an area to which the compressive force is applied by the compressive force presentation unit.

7. The pressure sensation presentation system according to claim 6, wherein
the control unit changes a compressive area in which the user and the compressive force presentation unit are in contact with each other.

8. The pressure sensation presentation system according to claim 6, wherein
the third physical stimulus includes
a step in which the area to which the compressive force is applied to the user by the compressive force presentation unit increases and the compressive force decreases, and
a step in which the area to which the compressive force is applied to the user by the compressive force presentation unit decreases and the compressive force increases.

9. The pressure sensation presentation system according to claim 7, wherein
the third physical stimulus includes
a step in which the compressive area increases and the compressive force decreases, and
a step in which the compressive area decreases and the compressive force increases.

10. The pressure sensation presentation system according to claim 1, wherein
the output apparatus includes a vibration presentation unit that applies a vibration stimulus as the physical stimulus to the user.

11. The pressure sensation presentation system according to claim 10, wherein
the vibration stimulus is a damped vibration.

12. The pressure sensation presentation system according to claim 11, wherein
the vibration stimulus includes a frequency component of 200 Hz or more and 1000 Hz or less.

13. The pressure sensation presentation system according to claim 1, wherein
the output apparatus further includes a warm sensation presentation unit that applies a warm sensation stimulus as the physical stimulus to the user.

14. The pressure sensation presentation system according to claim 13, wherein
the warm sensation presentation unit comes into contact with the user, and
the control unit changes a contact area in which the warm sensation presentation unit is in contact with the user when the warm sensation stimulus is applied to the user by the warm sensation presentation unit.

15. The pressure sensation presentation system according to claim 3, wherein
the third physical stimulus includes a plurality of the first steps and a plurality of the second steps.

16. A control apparatus, comprising
a generation unit that generates, on a basis of a determination result of a determination apparatus that determines a state of a preset action of the user, for an output apparatus that applies a physical stimulus for presenting a pressure sensation to the user,
a first driving signal to apply a first physical stimulus to the user when the state of the action of the user is a first state,
a second driving signal to apply a second physical stimulus to the user when the state of the action is a second state, and
a third driving signal to apply a third physical stimulus to the user in a transition from the first state to the second state, the third physical stimulus including at least one of an upwardly convex change or a downwardly convex change in an amount of physical stimulus.
